(19) United States
(12) Patent Application Publication
(10) Pub. No.: US 2010/0119638 A1
(43) Pub. Date: May 13, 2010

(54) PELLETING DIE AND METHOD FOR SURFACE HARDENING PELLETING DIES

(76) Inventors: Carl R. Allis, Crawfordsville, IN (US); Thomas R. Kanaby, West LaFayette, IN (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/267,496

(22) Filed: Nov. 7, 2008

(51) Int. Cl. B23P 15/24

(52) U.S. Cl. 425/222; 29/896.6

(57) ABSTRACT

A pelleting die is made of martensitic stainless steel and includes a plurality of extrusion holes form through the die. The surfaces of the die, including surfaces inside the extrusion holes, are hardened by gas nitriding or plasma nitriding. A martensitic stainless steel die can have a carbon content of at least 0.4%. A martensitic steel die can be made of SAE grade 420 steel which is plasma nitrided to produce hardened surfaces. Plasma nitriding can be performed at sufficiently a low temperature to avoid softening of the 420 steel core.

### FIELD OF THE INVENTION

This invention relates generally to pelletizing machinery and, more particularly, to a pelleting die and a method of surface hardening pelleting dies.

### BACKGROUND OF THE INVENTION

Various grains and/or other particulate material are mixed together to form the flowable material which is forced through perforations in a pelleting die so that the material attains a pellet-like shape upon exiting the perforations. The die should resist chemical attack and should have a surface that is sufficiently hard to resist abrasion from the flowable material Tremendous pelleting forces are applied to the die as the flowable material is forced through the perforations. The die may be damaged by the pelleting forces if the die surface and core are not properly matched in hardness. For example if the core is too hard the die will fail from fracture due to limited ductility; if the core is too soft it cannot support a hardened case.

Surface hardening of pelleting dies may improve wear resistance. However, conventional nitriding and other surface hardening methods require high temperatures which may make the core of the die too soft to provide sufficient support for the hardened surface during pelleting operations. Hot work tool steels, such has H-13, may be used to make pelleting dies since such steels resist softening at the higher conventional nitriding temperatures. However, conventional pelleting dies made of hot work tool steels and other grades of steel are still subject to breakage, and there is a continuing need to have dies which have a longer operational life and which improve efficiency and reduce the cost of pelleting operations.

### SUMMARY OF THE INVENTION

Briefly and in general terms, the present invention is directed to a pelleting die and a method of manufacturing a pelleting die.

In aspects of the present invention, a pelleting die comprises a tubular wall made of steel. The tubular wall has a plurality of extrusion holes formed through the tubular wall. The tubular wall includes an inner surface, an outer surface, and extrusion hole surfaces in the extrusion holes. The inner surface, the outer surface, and the extrusion hole surfaces are hardened using pulsed plasma.

In other aspects of the present invention, a method of manufacturing a pelleting die comprises forming a tubular wall made of steel. The tubular wall has a plurality of extrusion holes formed through the tubular wall. The tubular wall includes an inner surface, an outer surface, and extrusion hole surfaces in the extrusion holes. The method further comprises using a pulsed plasma to harden the inner surface, outer surface, and extrusion hole surfaces.

In further aspects of the present invention, a pelleting die comprises a wall made of 420 stainless steel, the wall having a plurality of extrusion holes formed through the wall, the wall including a cylindrical inner surface, a cylindrical outer surface, and extrusion hole surfaces in the extrusion holes. The inner surface, the outer surface, and the extrusion hole surfaces have a surface hardness from about Rc 60 to about Rc 75, and a core region of the wall has a core hardness from about Rc 42 to about Rc 52, the core region located between the inner surface and the outer surface.

In further aspects of the present invention, a method of manufacturing a pelleting die comprises forming a wall made of 420 stainless steel, the wall having a plurality of extrusion holes formed through the wall, the wall including a cylindrical inner surface, a cylindrical outer surface, and extrusion hole surfaces in the extrusion holes. The method further comprises hardening the inner surface, the outer surface, and the extrusion hole surfaces to a hardness from about Rc 60 to about Rc 75. The method further comprises maintaining a core region at a hardness from about Rc 42 to about Rc 52 subsequent to hardening of the inner surface, the outer surface, and the extrusion hole surfaces. The core region is located between the inner surface and the outer surface.

The features and advantages of the invention will be more readily understood from the following detailed description which should be read in conjunction with the accompanying drawings.

### BRIEF DESCRIPTION OF THE DRAWINGS

FIG. 1 is a partial, side cross-sectional view of a pelleting machine, showing a pelleting die inside a housing.

FIG. 2 is a front cross-sectional view of the pelleting die of FIG. 1 along arrows 2-2 in FIG. 1, showing flowable material being extruded through extrusion holes.

FIG. 3 is a schematic diagram of a plasma nitriding setup, showing a die inside a vacuum furnace.

FIG. 4 is a cross-sectional view of a portion of a die, showing inner and outer surfaces of the die having been hardened through nitriding, and surfaces in an extrusion hole which were not hardened.

FIG. 5 is a cross-sectional view of a portion of a die, showing inner and outer surfaces of the die and surfaces in an extrusion hole, all the surfaces having been hardened through nitriding.

### DETAILED DESCRIPTION OF THE INVENTION

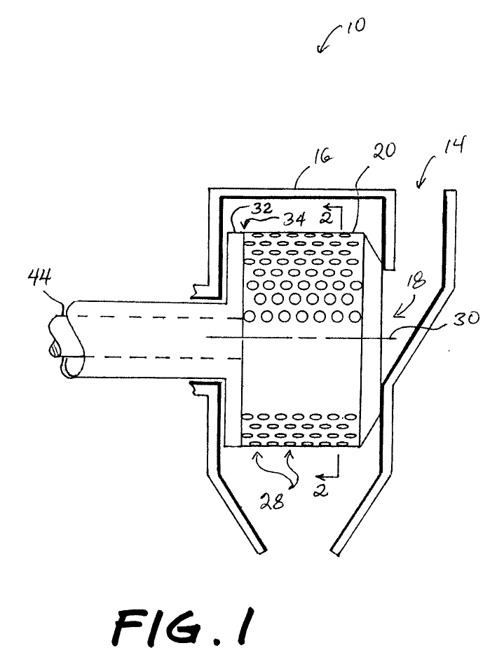

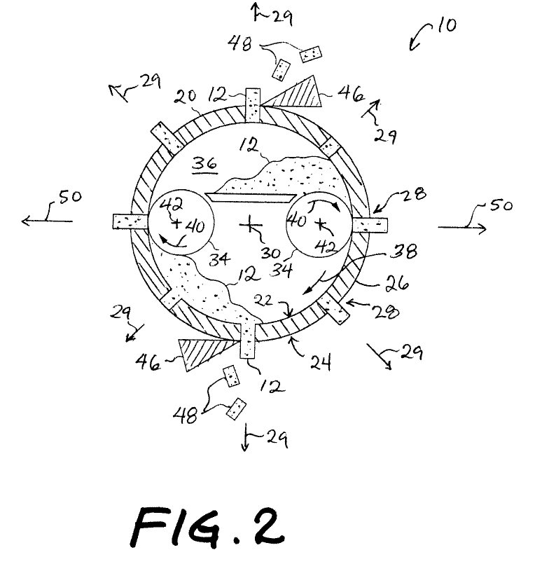

Referring now in more detail to the exemplary drawings for purposes of illustrating embodiments of the invention, wherein like reference numerals designate corresponding or like elements among the several views, there is shown in FIGS. 1 and 2 a pelleting machine 10 which may be used to form a variety of pellet products, such as pelletized animal feed and biomass fuel, from flowable material 12 composed of various grains and/or other particulate material. The flowable material may enter a top opening 14 of a housing 16 and is guided into the front end 18 of tubular die 20.

The die 20 has the shape of a hollow cylinder with inner and outer surfaces 22, 24 on a tubular wall 26. The tubular wall 26 includes a plurality of extrusion holes or perforations 28 through which the flowable material 12 is extruded. The extrusion holes 28 run in radial directions 29, 50 from the central axis 30 of the die. The die 20 is rotated about its central axis 30 by a quill 32 attached to the rear end 34 of the die. The die may be removed from the quill to allow for cleaning, maintenance, and replacement of the die. The quill 32 is operatively coupled to a motor which rotates the quill and die about the central axis 30.

Two or more cylindrical rollers 34 are located inside the central cavity 36 of the die 20. As the die 20 is moved in a rotational direction 38, the flowable material 12 is drawn and compressed between the inner surface 22 of the die and the outer surface of the rollers 34. This compressive action forces the flowable material 12 in the central cavity 36 to enter the perforations 28 and protrude radially outward from the outer surface 24 of the die 20. To facilitate compression, the rollers 36 may rotate in directions 40 about roller axes 42 that are offset or spaced at a distance from the central axis 30 of the die 20. The rollers may be mounted on an armature that is connected to a mainshaft 44 extending through a bore in the quill 32. The mainshaft may remain stationary as the quill and die rotate so that the roller axes 42 remain at fixed angular positions within the central die cavity 36.

With the roller axes 42 being stationary inside the die cavity 36, various parts of the die 20 repeatedly come into and out of proximity to the rollers 34 which push the flowable material 12 through the die. As such, the die 20 is subjected to cyclical stress and strain during rotation relative to the rollers 34, causing portions of the die adjacent the rollers to deflect radially outward in directions 50 from the central axis 30 so that the die takes on a slightly oblong or oval shape. In a die having an inside diameter 22 of about 36 inches (about 91.7 centimeters), such deflection can be as much as about one quarter of an inch (about six millimeters) in each direction 50.

The flowable material 12 that protrudes from the outer surface 26 of the die 20 may be sheared or cut off by blades 46 adjacent the outer surface 26. Rotation of the die 20 brings the protruding flowable material 12 into contact with the blades 26, so as to be cut away to form pellets 48.

The flowable material 12 may include grains, such as dried distiller's grain, corn pulp, and/or other materials of plant origin that have been heated and moistened. The various grains may be preconditioned prior to entering the die 20 to a carefully selected and controlled temperature and moisture content. In the case of making pelletized animal feed, the temperature may be selected to be sufficiently high to destroy any microorganisms harmful to animals. For example, the flowable material 12 may be heated to at least 82 degrees C. (180 degrees F.) to kill salmonella and other bacteria.

The moisture content may be selected to allow the grains to bind together and flow through the extrusion holes 28 so as to form pellets having a desired size and consistency. Dried distiller's grain when made wet forms sticky globs which tend to adhere to surfaces of the die 20 and resist extrusion through the perforations 28. Resistance to extrusion increases the power required to rotate the die and this increases cyclic pelleting forces placed on the die.

The die 20 should have sufficient toughness or ductility to withstand the cyclic forces of the pelleting process. The die 20 should also have sufficient wear and corrosion resistance to withstand abrasion by solid matter in the flowable material and chemical attack by high temperature moisture and any chemical additives in the flowable material. The surfaces of the die 20 should be relatively smooth to minimize resistance of the flowable material to extrusion. Applicant has found that these and other factors are addressed by nitriding a die made of martensitic stainless steel in accordance with embodiments of the present invention. The term “martensitic” refers generally to a body centered tetragonal crystal structure in a steel alloy.

Nitridization or nitriding, through plasma, gas, salt or fluidized bed methods introduces nitrogen in the surface of a steel pelleting die, which hardens the surface. Nitriding is performed at relatively high temperatures and causes formation of nitride precipitates that harden the die surface up to a depth in the order of several hundred micrometers. The hardened region surrounding a relatively softer core is referred to as a hardened case.

In some embodiments, the hardened case may be formed by elements and compounds other than nitrogen including but not limited to carbon and boron. In some embodiments, the surfaces of a die made of 420 stainless steel (“420-SS”) are hardened by a gas nitriding process. Gas nitriding may be performed by holding the die at a suitable temperature, referred to as “nitriding temperature,” while in contact with a nitrogenous gas. The nitriding process may be performed by placing the die in a furnace containing the nitrogenous gas. The nitrogenous gas may be ammonia (NH₃). The nitriding temperature should be high enough to dissociate the ammonia into its separate elements of 1 part nitrogen and 3 parts hydrogen. The nitriding temperature may be between about 495 degrees C. (925 degrees F.) and about 565 degrees C. (1050 degrees F.). In further embodiments, the nitriding temperature may be within a narrower range, from about 524 degrees C. (975 degrees F.) to about 543 degrees C. (1010 degrees F.).

In some embodiments, nitriding of a die made of 420-SS at a nitriding temperature in the range from about 524 degrees C. (975 degrees F.) to about 543 degrees C. (1010 degrees F.) results in a die surface hardness as high as Rc 70, and a die core hardness in the range Rc 38 to 41. Rc refers to the Rockwell C scale of hardness. The 420-SS die may be subjected to pelleting forces on its surface that require a greater core hardness in order support the hardened case and prevent cracking of the die. Applicant has found that the core hardness of a 420-SS die can be increased by limiting exposure of the die to high temperatures.

In some embodiments, nitriding of the 420-SS die may be performed using a plasma (ion) nitriding process involving an electrical charge that produces a glow-discharge phenomenon.

As shown in FIG. 3, a die 60 may be placed in a container, such as a vacuum furnace 62, in which internal temperature and pressure may be carefully controlled. Applying a voltage across the die and container wall and reducing pressure inside the container allows a plasma to form around the die. The pressure may be 5.0 millibars (mb). The resulting plasma allows for proper nitridization by helping to heat the die to a nitriding temperature and removing passivated layers and oxide films that might be present on the die surface. Passivated layers and oxide films on the die would inhibit or prevent nitriding.

Still referring to FIG. 3, a voltage generator 64 is connected to the die and furnace to provide an electrical charge. The die is electrically insulated from the furnace to allow the die to be a cathode and the furnace wall to be an anode so as to negatively charge the die. A gas supply 66 introduces nitrogen bearing gas into the furnace. As the gas is introduced, vacuum pressure inside the furnace is maintained by a vacuum pump 68 connected to the furnace. The gas mixture may include nitrogen gas and hydrogen gas. Positive ions from the gas are attracted to and bombard the die so as to remove passivated layers and oxide films. Nitrogen penetrates the surface to form a hardened case. The resulting drop in potential, when the positive ions bombard the die, emits visible radiation, referred to as “glow.”

As indicated above, the die is heated by the plasma. The furnace may also include radiant heaters for heating the die. In some embodiments, the nitriding temperature for the plasma process is controlled to below 524 degrees C. (975 degrees F.) in order to have a core hardness in the 420-SS die greater than Rc 41.

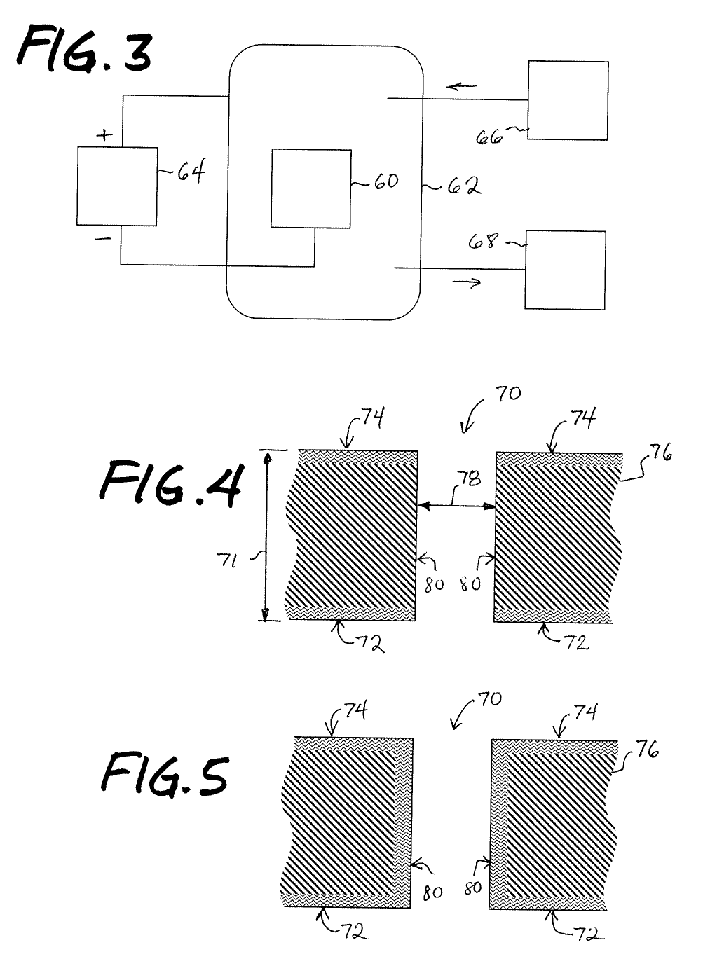

Nitriding temperature below 524 degrees C. (975 degrees F.) may result in improper nitriding of die surfaces in the extrusion holes of the die. The improper nitriding will be evident in the lack of a nitrided case and/or improper phase structure and uniformity of the case. In some embodiments, such as shown, for example, in FIG. 4, an extrusion hole 70 may be excessively deep or insufficiently wide or both, which prevents proper nitriding of surfaces in the extrusion holes. The depth of the extrusion hole is the distance 71 from the inner surface 72 to the outer surface 74 of the die 76. The width of the extrusion hole is the distance 78 across opposite surfaces 80 inside the extrusion hole. When the extrusion hole is circular, the width may be the diameter of the hole.

Without being limited to a particular theory of operation, it is believed that when extrusion holes are of a certain depth and/or width, the electrical charge arcs across the extrusion holes which prevents the plasma covering the die, visible as a “glow seam,” from sufficiently penetrating the extrusion holes of the die and nitriding the surface in the hole. Arcing may also damage the extrusion hole surfaces 80. In FIG. 4, plasma has not penetrated the extrusion hole 70, which resulted in only the inner and outer surfaces 72, 74 being nitrided (indicated by wavy cross hatch lines).

As shown in FIG. 4, applicant has found that having a nitriding temperature at or about 540 degrees C. (1004 degrees F.) during the plasma nitriding process allows the plasma in some embodiments to penetrate extrusion holes 70 and, thereby, allow for nitriding of the extrusion hole surfaces 80 in the extrusion holes. However, as previously indicated, increasing the nitriding temperature above 524 degrees C. (975 degrees F.) may cause the core hardness of the die to be insufficient to support the hardened case during operation of the die.

Applicant has found that, under certain process conditions, a 420-SS die can be plasma nitrided at a nitriding temperature as low as 460 degrees C. (860 degrees F.) while allowing plasma to enter the extrusion holes of the die, which results in a surface hardness range of Rc 60 to Rc 75 and a core hardness range of Rc 42 to Rc 52. In some embodiments, the difference between the surface hardness Rc value and core hardness Rc value is less than twenty-nine, which was the minimum difference between surface and core Rc values exhibited after nitriding the 420-SS die described above at a temperature in the range from about 524 degrees C. (975 degrees F.) to about 543 degrees C. (1010 degrees F.). The core hardness range of Rc 42 to Rc 52 provides greater support of the hardened case than the core hardness range of Rc 38 to Rc 41 in 420-SS dies nitrided at higher temperatures while providing improved ductility over dies made of tool steel, such as H-13.

In some embodiments, a pulsed current or a pulsating electrical charge is applied in combination with a furnace pressure of 1.2 mb to 6.0 mb, which allows plasma to enter extrusion holes having a diameter of about 2.0 mm to 19.0 mm while maintaining a nitriding temperature as low as 460 degrees C. (860 degrees F.). The different pressures may be required based upon the number and size of holes in the pelleting die. For example, the more holes in the pelleting die, the lower the pressure. Also, the fewer the number of holes and/or the greater the hole size, the higher pressure may be required. Current may be pulsed at a frequency in a range from about 2 kHz to about 20 kHz and at a duty cycle in a range from about 50% to about 80%. Such pulsing may produce a pulsed plasma which enters the extrusion holes. The ratio of nitrogen gas to hydrogen gas may be in a range of about 3:1 to 1:8. The gas mixture may vary based upon the type of phase structure that is desired in the nitride case.

For proper nitridization of extrusion holes at low nitriding temperatures, the electrical charge applied, the frequency, the duty cycle, the furnace pressure, and the ratio of nitrogen gas to hydrogen gas may be varied depending on the surface area of the die, which is affected by the number and diameter of extrusion holes in the die. For example, in some embodiments having extrusion hole diameters at or about 4.5 mm, suitable parameters for proper nitriding are a vacuum pressure at or about 1.8 mb, a pulse frequency at or about 6 kHz, and a process temperature at or about 460 degrees C. (860 degrees F.).

It will be appreciated that various grades or classes of steel including martensitic and ferritic stainless steel, along with Duplex alloys, AISI 4000, 5000, 6000, 8000, 9000 series, and precipitation hardening (PH) steels may be used to improve operational characteristics relative to hot work tool steels and other steel grades. Non-limiting examples of martensitic stainless steels and other steels that may be used in the present invention are shown in Table I. Table I shows an exemplary chemical composition for each grade of steel listed. Carbon (C) is added to a steel composition to increase hardness and strength. In some embodiments, the steel used to make the die has a carbon content of at least about 0.10% wt. In further embodiments, the steel used to make the die has a carbon content of about 0.4% wt or greater. Grade 420 steel can have a carbon content of 0.4% wt or more.

TABLE I

| AISI/ | | | | | | | | | |
|---|---|---|---|---|---|---|---|---|---|
| SAE | UNS | % C | % Mn | % P | % S | % Si | % Ni | % Cr | % Mo |
| 4047 | G40470 | 0.45-0.50 | 0.70-0.90 | 0.035 | 0.04 | 0.15-0.35 | * | * | 0.20-0.30 |
| 4140 | G41400 | 0.38-0.43 | 0.75-1.00 | 0.035 | 0.04 | 0.15-0.35 | * | 0.80-1.10 | 0.15-0.25 |
| 4150 | G41500 | 0.48-0.53 | 0.75-1.00 | 0.035 | 0.04 | 0.15-0.35 | * | 0.80-1.10 | 0.15-0.25 |
| 4340 | G43400 | 0.38-0.43 | 0.60-0.80 | 0.035 | 0.04 | 0.15-0.35 | 1.65-2.00 | 0.70-0.90 | 0.20-0.30 |
| 4615 | G46150 | 0.13-0.18 | 0.45-0.65 | 0.035 | 0.04 | 0.15-0.35 | 1.65-2.00 | * | 0.20-0.30 |
| 4720 | G47200 | 0.17-0.22 | 0.50-0.70 | 0.035 | 0.04 | 0.15-0.35 | 0.90-1.20 | 0.35-0.55 | 0.15-0.25 |
| 4817 | G48170 | 0.15-0.20 | 0.40-0.60 | 0.035 | 0.04 | 0.15-0.35 | 3.25-3.75 | * | 0.20-0.30 |
| 5160 | G51600 | 0.56-0.64 | 0.75-1.00 | 0.035 | 0.04 | 0.15-0.35 | * | 0.70-0.90 | * |
| 630 | S17400 | 0.07 | 1.0 | 0 | 0. | 1.0 | 4.0 | 17.0 | * |
| 6150 | G61500 | 0.48-0.53 | 0.70-0.90 | 0.035 | 0.04 | 0.15-0.35 | * | 0.80-1.10 | 0.15 min |
| 8640 | G86400 | 0.38-0.43 | 0.75-1.00 | 0.035 | 0.04 | 0.15-0.35 | 0.40-0.70 | 0.40-0.60 | 0.15-0.25 |
| 8740 | G87400 | 0.38-0.43 | 0.75-1.00 | 0.035 | 0.04 | 0.15-0.35 | 0.40-0.70 | 0.40-0.60 | 0.20-0.30 |
| 8822 | G88220 | 0.20-0.25 | 0.75-1.00 | 0.035 | 0.04 | 0.15-0.35 | 0.40-0.70 | 0.40-0.60 | 0.30-0.40 |
| 410SS | S41000 | 0.15 | 1 | 0.035 | 0.04 | 1 | | 11.5-13.5 | |
| 420SS | S42000 | 0.15 min | 1 | 0.035 | 0.04 | 1 | | 12-14 | |
| 440A | S44002 | 0.60-0.75 | 1 | 0.035 | 0.04 | 1 | | 16-18 | 0.75 |
| 17-4PH | S17400 | 0.07 | 1 | 0.035 | 0.04 | 1 | 3-5 | 15.5/17.5 | 4.0% Cu |

In other embodiments, the steel used to make the die is not a steel within any one or more of class H (hot work tool steels), class A (air-hardening, cold-work tool steels), class D (high-carbon, high-chromium cold work tool steels), class T (tungsten high-speed tool steels), and class M (molybdenum high-speed tool steels). Each one of these classifications includes multiple types of steels as defined by the American Iron and Steel Institute (AISI). In some embodiments, the steel used to make the die is a “non-tool” steel, which is a steel not in class H, class A, class D, class T, and class M.

Nitrided 420-SS pelleting dies have exhibited greater toughness and fatigue resistance, resulting in an operational life greater than that of pelleting dies made of nitrided H-13 hot work tool steel. In many cases, dies made from nitrided H-13 hot work tool steel have a surface hardness at or around Rc 70 and a core hardness at or around Rc 55. Applicant believes that Rc 55 is too hard and is the source of brittle fracture seen in many H-13 dies. By comparison, some embodiments of dies made of nitrided 420-SS stainless steel which were pulse plasma nitrided at temperatures below 524 degrees C. (975 degrees F.) have a surface hardness at or around Rc 70 and a core hardness at or around Rc 50. Applicant believes that the five point drop from Rc 55 to Rc 50 is responsible, at least in part, for the greater operational life exhibited by nitrided 420-SS dies. At the same time, the core hardness of Rc 50 is not overly soft and provides sufficient support for the hardened surface. In addition to having greater operational life, nitrided 420-SS pelleting dies have resulted in a reduction of over 20% in the amperage load for running pellet mills, which equates to significant energy cost savings.

It is believed that the lower power requirements arise, at least in part, from improved flow ability of pelleting material in nitrided 420-SS dies as compared to nitrided H-13 dies and other dies that have been neutral hardened, carburized, or carbon-nitrided. Applicant has found that a temperature increase in the material being pelleted causes proteins in the pelleting material to breakdown and restrict flow ability. In dies that have been hardened through neutral hardening, carburization, or carbon-nitridization, flow ability of the pelleting material through the die decreased when the temperature of the pelleting material increased. In nitrided H-13 dies, flow ability of the pelleting material remained unchanged when temperature increased. In nitrided 420-SS dies, flow ability of the pelleting material remained unchanged or improved when the temperature of the pelleting material increased.

Dies made of 420-SS, as well as other steel materials, which have been conventionally hardened, without nitridization, often need deflourinated phosphate to be added to the pelleting material to polish surfaces in the extrusion holes and, thereby, prevent the extrusion holes from being plugged with pelleting material. Applicant has also found that nitrided martensitic stainless steel dies do not need the addition of deflourinated phosphate, which reduces material costs. Also, nitrided martensitic stainless steel dies have been found to be capable of processing material with a higher concentration of dried distiller's grain than martensitic steel dies that have been hardened without nitriding. Dried distillers grain is a byproduct of ethanol production from corn and is a less costly ingredient than virgin corn. Thus, use of nitrided martensitic stainless steel dies with a greater concentration of dried distiller's grain allows pellet producers to further reduce material costs.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A pelleting die comprising:
a tubular wall made of steel, the tubular wall having a plurality of extrusion holes formed through the tubular wall, the tubular wall including an inner surface, an outer surface, and extrusion hole surfaces in the extrusion holes;
wherein the inner surface, the outer surface, and the extrusion hole surfaces are hardened using pulsed plasma.

2. The pelleting die of claim 1, wherein the inner surface, outer surface, and extrusion hole surfaces have a hardness from about Rc 60 to about Rc 75.

3. The pelleting die of claim 2, wherein a core region of the die below the inner surface, outer surface, or the extrusion hole surface has a hardness of at least about Rc 42.

4. The pelleting die of claim 3, wherein the steel is selected from the group consisting of martensitic stainless steel, class AISI 4000, class AISI 5000, class AISI 6000, class AISI 8000, class AISI 9000, and precipitation hardening steel.

5. The pelleting die of claim 1, wherein the steel is a non-tool steel.

6. The pelleting die of claim 1, wherein the steel is a 420 stainless steel and the inner surface, the outer surface, and the extrusion hole surfaces are pulse plasma nitrided at a nitriding temperature below 524 degrees C. (975 degrees F.).

7. The pelleting die of claim 6, wherein the nitriding temperature is at or about 460 degrees C. (860 degrees F.).

8. The pelleting die of claim 6, wherein a core material of the die below the inner surface, outer surface, or the extrusion hole surface has a hardness of at least about Rc 42.

9. A method of manufacturing a pelleting die, comprising:
forming a tubular wall made of steel, the wall having a plurality of extrusion holes formed through the tubular wall, the tubular wall including an inner surface, an outer surface, and extrusion hole surfaces in the extrusion holes; and
using a pulsed plasma to harden the inner surface, outer surface, and extrusion hole surfaces.

10. The method of claim 9, wherein using the pulsed plasma includes nitriding the tubular wall to produce a hardness from about Rc 60 to about Rc 75 at the inner surface, the outer surface, and the extrusion hole surfaces.

11. The method of claim 10, wherein using the pulsed plasma includes nitriding the tubular wall to produce a hardness from about Rc 42 to about Rc 52 at a core region of the tubular wall below the inner surface, the outer surface, or the extrusion hole surfaces.

12. The method of claim 11, wherein the steel is selected from the group consisting of martensitic stainless Steel, class AISI 4000, class AISI 5000, class AISI 6000, class AISI 8000, class AISI 9000, and Precipitation Hardening steel.

13. The method of claim 9, wherein the steel is a 420 stainless steel and using the pulsed plasma includes nitriding the tubular wall at a nitriding temperature below 524 degrees C. (975 degrees F.).

14. The method of claim 13, wherein the nitriding temperature is at or about 460 degrees C. (860 degrees F.).

15. The method of claim 13, wherein using the pulsed plasma includes producing a hardness from about Rc 42 to about Rc 52 at a core region of the tubular wall below the inner surface, the outer surface, or the extrusion hole surfaces.

16. The method of claim 13, wherein using the pulsed plasma includes placing the tubular wall inside a container and providing a voltage across the tubular wall and the container with a pulsed electrical current having a frequency in a range from about 2 kHz to about 20 kHz and a duty cycle in a range from about 50% to about 80%.

17. A pelleting die comprising:
a wall made of 420 stainless steel, the wall having a plurality of extrusion holes formed through the wall, the wall including a cylindrical inner surface, a cylindrical outer surface, and extrusion hole surfaces in the extrusion holes;
wherein the inner surface, the outer surface, and the extrusion hole surfaces have a surface hardness from about Rc 60 to about Rc 75, and a core region of the wall has a core hardness from about Rc 42 to about Rc 52, the core region located between the inner surface and the outer surface.

18. The pelleting die of claim 17, wherein the surface hardness is at or about Rc 70 and the core hardness is at or about Rc 50.

19. The pelleting die of claim 18, wherein the inner surface, the outer surface, and the extrusion hole surfaces are nitrided.

20. A method of manufacturing a pelleting die, comprising:
forming a wall made of 420 stainless steel, the wall having a plurality of extrusion holes formed through the wall, the wall including a cylindrical inner surface, a cylindrical outer surface, and extrusion hole surfaces in the extrusion holes;
hardening the inner surface, the outer surface, and the extrusion hole surfaces to a hardness from about Rc 60 to about Rc 75; and
maintaining a core region at a hardness from about Rc 42 to about Rc 52 subsequent to hardening of the inner surface, the outer surface, and the extrusion hole surfaces, the core region located between the inner surface and the outer surface.

21. The method of claim 20, wherein hardening of the inner surface, the outer surface, and the extrusion hole surfaces includes performing the following concurrently:
subjecting the wall to a vacuum pressure from about 1.2 mb to about 6.0 mb;
generating a pulsed plasma on the wall using a current having a pulse frequency from about 2 kHz to about 20 kHz; and
maintaining the wall at a process temperature below 524 degrees C. (975 degrees F.).

22. The method of claim 21, wherein the vacuum pressure is a function of the diameter of the extrusion holes in which pressure increases with an increase in diameter.
